(19) United States
(12) Patent Application Publication
(10) Pub. No.: US 2018/0183861 A1
(43) Pub. Date: Jun. 28, 2018

(54) INTERNET-OF-THINGS TRANSACTION RESORUCE WITH FINITE STATE AUTOMATA

(71) Applicants: Ned M. Smith, Beaverton, OR (US); Gregory Burns, Seattle, WA (US); Ravi Subramaniam, San Jose, CA (US); Geoffrey H. Cooper, Palo Alto, CA (US); Guy Louis AlLee, JR., Portland, OR (US)

(72) Inventors: Ned M. Smith, Beaverton, OR (US); Gregory Burns, Seattle, WA (US); Ravi Subramaniam, San Jose, CA (US); Geoffrey H. Cooper, Palo Alto, CA (US); Guy Louis AlLee, JR., Portland, OR (US)

(21) Appl. No.: 15/393,034

(22) Filed: Dec. 28, 2016

(51) Int. Cl. H04L 29/08

(52) U.S. Cl. CPC H04L 67/104; H04L 67/42; H04L 67/12

(57) ABSTRACT

Cloud container resource binding and tasking using keys is generally described herein. An exemplary device to perform a transaction with a peer device includes a server having a transaction resource finite state automaton (FSA) to perform the transaction. The transaction resource includes a current state property identifying a current state and a state graph property defining a protocol for the transaction. The example device may further include a client having a transaction engine to interface with the transaction resource to post messages to the peer device based on the current state property and the state graph property.

### BACKGROUND

As Internet-of-Things (IoT) devices become more prevalent, frameworks may balance between factors such as complexity, compatibility, security, and throughput. As different types of transactions are developed, protocol complexity and compatibility comes to a forefront in order to maintain efficient connectivity between devices.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates a functional block diagram of a transaction implementation system between two devices using finite state automata (FSA) implemented as a transaction resource in accordance with some embodiments of the disclosure.

FIG. 2 depicts a block diagram of an exemplary transaction graph according to some embodiments of the disclosure.

FIG. 3 is a block diagram of a transaction system having an IoT device according to some embodiments of the disclosure.

FIG. 4 is a block diagram of a transaction system having an IoT device according to some embodiments of the disclosure.

FIG. 5 is a block diagram of a key exchange transaction system having an IoT device according to some embodiments of the disclosure.

FIG. 6 depicts a block diagram of an exemplary transaction graph in accordance with an embodiment of the disclosure.

FIG. 7 depicts a block diagram of an exemplary sigma version 2 key exchange transaction graph in accordance with an embodiment of the disclosure.

FIG. 8 illustrates a flow diagram of a method to a transaction with a peer device in accordance with some embodiments of the disclosure.

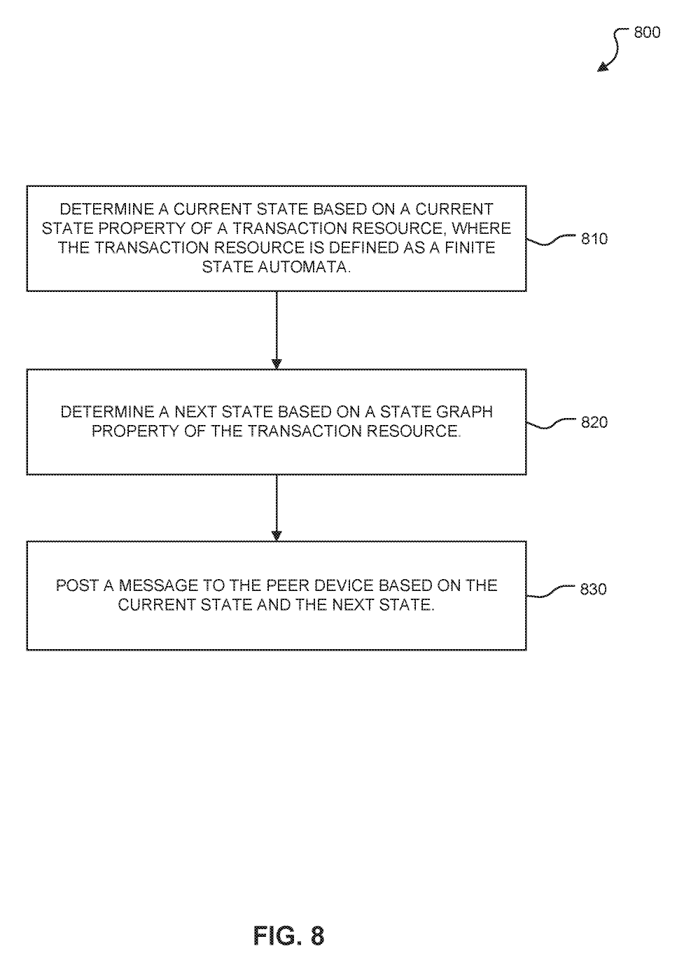

FIG. 9 illustrates a flow diagram of a method to a transaction with a peer device in accordance with some embodiments of the disclosure.

FIG. 10 is a block diagram illustrating a machine in the example form of a computer system, within which a set or sequence of instructions may be executed to cause the machine to perform any one of the methodologies discussed herein, according to an example embodiment.

### DETAILED DESCRIPTION

Certain details are set forth below to provide a sufficient understanding of embodiments of the disclosure. However, it will be clear to one skilled in the art that embodiments of the disclosure may be practiced without various aspects of these particular details. In some instances, well-known circuits, control signals, timing protocols, computer system components, and software operations have not been shown in detail in order to avoid unnecessarily obscuring the described embodiments of the disclosure.

Some frameworks may apply a declarative model for describing resource interactions among IoT devices. This may be well suited for using a representational state transfer (RESTful) approach to distributed computing. RESTfull behavior may allow servers to remain stateless as a strategy for improved scalability. However, in some interactions, it may be necessary to maintain protocol state. For example, when provisioning IoT devices into a network, settings, polices, and credentials may iterate through multiple update interactions before completing a transaction. An incomplete configuration may leave a device in an undefined operational state, where the configuration is either to be completed or is to be rolled back to some other more primitive state. Other examples of transactions that may require an ability to maintain protocol state may include key exchange, key management, on-boarding and transaction processing. Another approach may be to use remote method invocation (RMI). The RMI approach may use an underlying network layer to implement a reliable transport that ensures sequencing of remote method invocations. The RMI approach may also rely on code interpreters (e.g., python interpreter) to define subroutines implementing sequences of remote method invocation semantics. However, resource abstraction may be applied in such a way that a transaction may be described using resources. For example, a ‘transactional resource’ concept may be applied that implements a finite state automaton (FSA), which ensures a series of RESTful exchanges either completes or rolls-back to a known start state. However, a transactional resource may not prevent an attacker from emulating a known good FSA, while implementing a rogue FSA. To address this challenge a secure transactional resource may be implemented, where RESTful messages are protected by a secure envelope and transactional states may be protected by a trusted execution environment (TEE). Further, key exchange resources may be implemented as extensions of transaction resources. In some examples, the key exchange resources may implement key exchange protocols using a declarative model for the FSA.

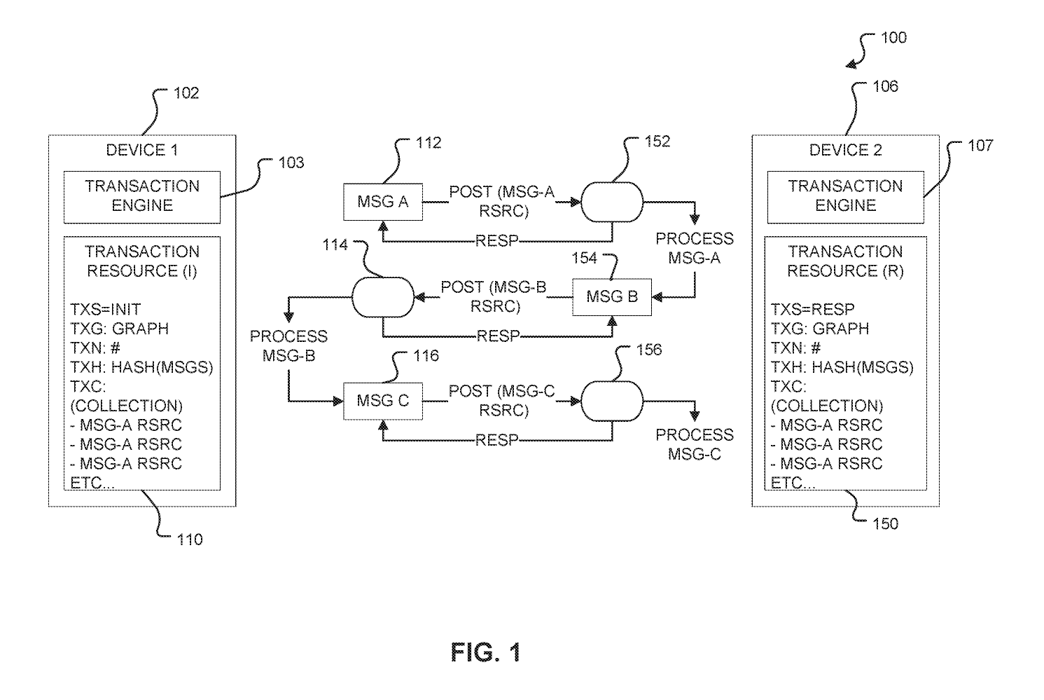

FIG. 1 illustrates a functional block diagram of a transaction implementation system 100 between two devices using finite state automata (FSA) implemented as a transaction resource in accordance with some embodiments of the disclosure. The system 100 may include a device 102 and a device 106. The device 102 may include a transaction engine 103 and a transaction resource 110. The device 106 may include a transaction engine 107 and a transaction resource 150. The transaction engine 103 and the transaction engine 107 may use the transaction resource 110 and the transaction resource 150, respectively, to perform a transaction between the device 102 and the device 106.

Each of the transaction resource 110 and the transaction resource 150 may include resource attributes such as resource type indicating the type of transaction resource, whether the transaction resource 110 or the transaction resource 150 is discoverable by peer devices, and interfaces supported by the transaction resource 110 and the transaction resource 150. Each of the transaction resource 110 and the transaction resource 150 may further include resource properties, such as a current state of a transaction (TXS), a graph that defines reachable states/transitions (TXG, a collection resource with references to transaction message resources (TXC), a rolling hash of transactional messages exchanged (TXH). In some examples, the transaction resource 110 and the transaction resource 150 may further include a transaction identification (TXI) property and/or a hash algorithm property (TXHALG) that defines the hash algorithm used in TXH.

In operation, the device 102 and the device 106 may perform an exemplary transaction that includes an exchange of several messages. The transaction engine 103 and the transaction engine 107 may execute the transaction protocol using the transaction resource 110 and the transaction resource 150, respectively. The transaction engine 103 and the transaction engine 107 may rely on a transaction graph TXG to determine subsequent states. The transaction resource 110 may be an initiator and the transaction resource 150 may be a responder.

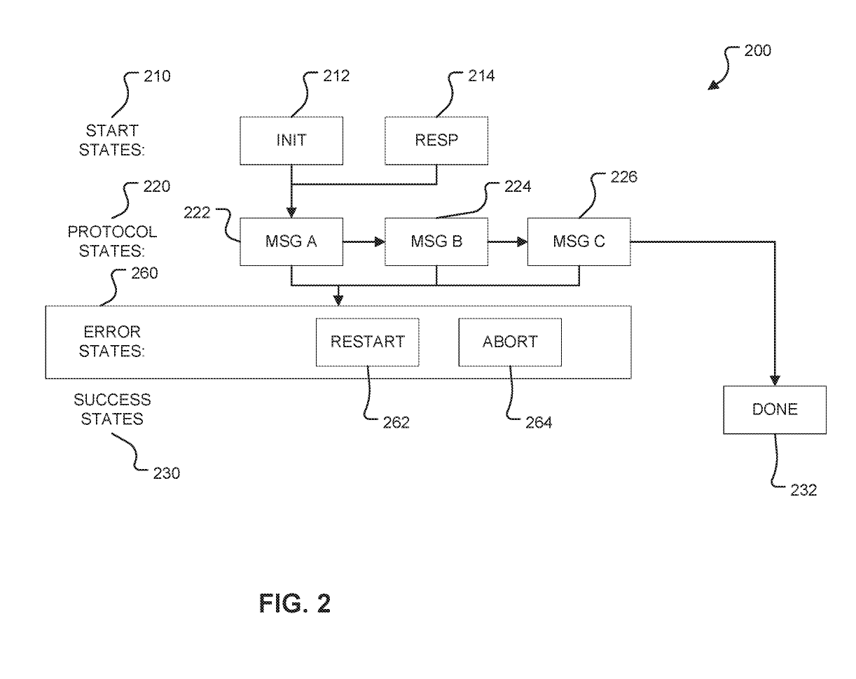

FIG. 2 depicts a block diagram of an exemplary transaction graph (TXG) 200 in accordance with an embodiment of the disclosure. The TXG 200 may include a FSA. The TXG 200 may include start states 210, protocol states 220, error states 260, and success states 230. The start states 210 may include an init state 212 and a resp state 214. The protocol states 220 may include a MSG A state 222, a MSG B state 224, and a MSG C state 226. The error states 260 may include an abort state 262 and a restart state 264. The success states 230 may include a done state 232. As depicted in FIG. 2, the TXG 200 defines a flow through a transaction protocol, with a current state dictating a next state. For example, if currently in a MSG A state 222, then a next possible state would be a MSG B state 224 or an error state 260. The TXG 200 may continue until the restart state 264 is reached or until the done state 232 is reached.

The transaction resource 110 may start in the init state 212, as defined by its respective TXS. The transaction resource 150 may start in the RESP state resp state 214, as defined by its respective TXS. The transaction engine 103 may post a MSG A 112 to the transaction engine 107. Responsive to receipt of the MSG A receipt 152, the transaction engine 107 may respond to the MSG A 112, process the MSG-A using the transaction resource 150, and may update a TXS to the MSG A state 222. Responsive to receiving the response of successful receipt, the transaction engine 103 may update the TXS of the transaction resource 110 to the MSG A state 222. Using the TXG 200, the transaction engine 107 may determine that the MSG B state 224 is a next state. The transaction engine 107 may post the MSG B 154 to the transaction engine 103. Responsive to receipt of the MSG B receipt 114, the transaction engine 103 may respond to the MSG B 154, process the MSG-B using the transaction resource 110, and update a TXS to the MSG B state 224. Responsive to receiving the response of successful receipt, the transaction engine 107 may update the TXS of the transaction resource 150 to the MSG B state 224.

Using the TXG 200, the transaction engine 103 may determine that the MSG C state 226 is a next state. The transaction engine 103 may post the MSG C 116 to the transaction engine 107. Responsive to receipt of the MSG C receipt 156, the transaction engine 107 may respond to the MSG C 116, process the MSG-C using the transaction resource 150, and may update a TXS of the transaction resource 150 to the MSG C state 226. Responsive to receiving the response of successful receipt, the transaction engine 103 may update the TXS of the transaction resource 110 to the MSG C state 226. Using the TXG 200, the transaction engine 107 may determine that the done state 232 is a next state. The transaction engine 107 may present an observation of the state being in the done state 232. Upon receipt, the transaction engine 103 may notify the transaction engine 107 of the done state 232. The transaction engine 103 and the transaction engine 107 may update the TXS of the transaction resource 110 and of the transaction resource 150, respectively, to the done state 232. By waiting to move a state forward until receiving a response, the transaction engine 103 and the transaction engine 107 may ensure that the transaction resource 110 and the transaction resource 150 remain in consistent states.

A benefit to this system 100 is that, after posting a message, the transaction engine 103 (or the transaction engine 107) may return to doing other tasks, or going to sleep, knowing that when the transaction engine 107 (or the transaction engine 103) is ready to POST a subsequent message, it will receive a notification to wake up and/or listen for activity from the transaction engine 107 (or the transaction engine 103). Notifications may also be used to signal when it is appropriate to free computing resources allocated to perform the transaction. For example, the abort state 262 or the restart state 264 notification may cause the device 102 or the device 106 to free memory used to contain message buffers and temporary files.

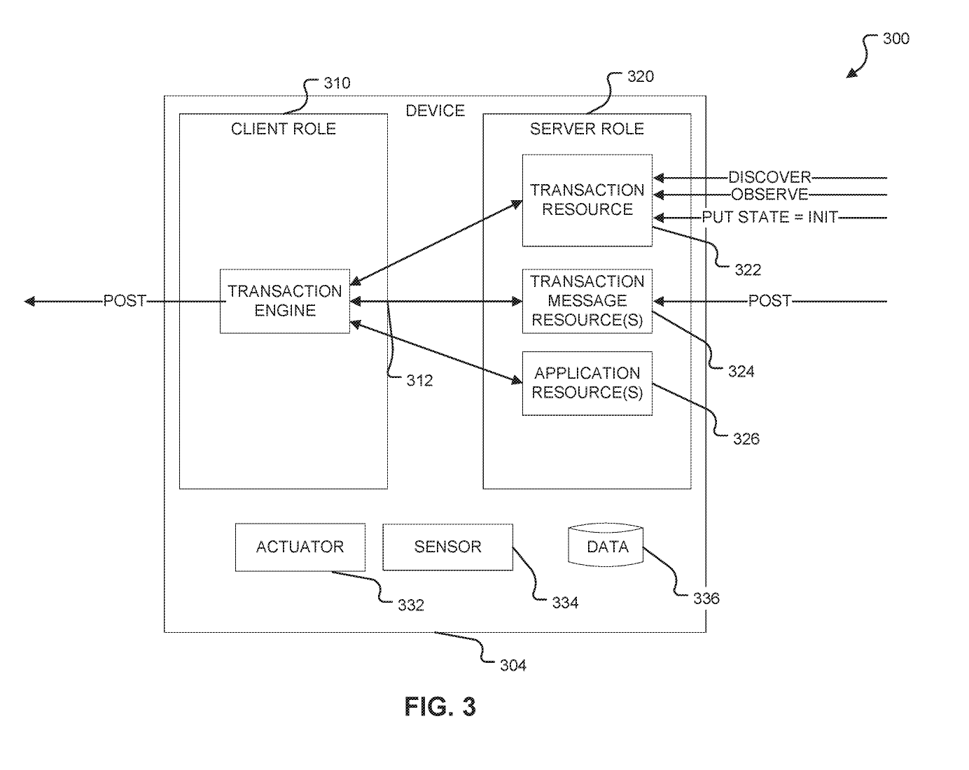

FIG. 3 is a block diagram of a transaction system 300 having an IoT device 304 according to some embodiments of the disclosure. The IoT device 304 may include both client components (e.g., to transmit messages/data) and server components (e.g., to receive messages/data) in a single device. Thus, the IoT device 304 may include a client 310 and a server 320. The client 310 may include a transaction engine 312. The server 320 may include a transaction resource 322, transaction message resource(s) 324, and application message resource(s) 326. In some examples, the IoT device 304 may further include one or more of an actuator 332 to perform a mechanical operation, a sensor 334 to sense environmental data, or a memory 336 to store data.

The transaction resource 322 may include resource attributes such as resource type (RT) to indicate the type of transaction resource, whether the transaction resource 322 is discoverable by peer devices, and interfaces supported by the transaction resource 322. The transaction resource 322 may further include resource properties, such as a current state of a transaction (TXS), a graph that defines reachable states/transitions (TXG, a collection resource with references to transaction message resources (TXC), a rolling hash of transactional messages exchanged (TXH). In some examples, the transaction resource 322 may further include a transaction identification (TXI) property and/or a hash algorithm property (TXHALG) that defines the hash algorithm used in TXH. The transaction engine 312 may be informed by the transaction resource 322 on the server 320 on the same platform regarding a current state TXS and an authorized state graph TXG. The transaction engine 312 may use the state graph TXG of the transaction resource 322 to control when to POST messages that further the protocol and when to take remedial actions. The transaction engine 312 may be further informed by the transaction message resource(s) 324 regarding types of information that are acceptable to POST to a peer device (not shown). The transaction resource 322, the transaction message resource(s) 324, and the application message resource(s) 326 may be hosted by the server 320 on the IoT device 304 so that POST responses originating from the peer device may likewise continue the transaction. The transaction resource 322 may also receive discovery messages and observe messages from the peer device. The transaction resource 322 may be discoverable, and the discover messages may be a mechanism by which peer devices discover the transaction resource 322. Information associated with the transaction resource 322 may be transmitted to the peer device, and the peer device may use the information to construct an instance of the transaction resource 322 in order to complete a transaction defined by the transaction resource 322 with the IoT device 304. The transaction resource 322 may also receive an observe request from the peer device and may provide subsequent notifications to the peer device in response to receiving the observe request.

In some examples, after the IoT device 304 has performed a discovery of transaction resources of another peer device, the IoT device 304 may perform introspection of the discovered transaction resources to establish whether or not the peer device has any overlapping transaction resource FSAs. FSA overlap may be achieved using a resource type RT comparison, However, if the peer device uses another framework that defines resource types differently, FSA overlap may also be determined based on logical analysis of the FSA expression. Using graph theory, a peer transaction resource FSA that is isomorphic to a first FSA can be ‘executed’ by both entities even though the FSA type information is dissimilar or the FSAs are from different IoT Frameworks. For example, a mapping function between a first IoT Framework and a second IoT Framework may apply graph analysis to establish that the two FSA protocols are equivalent in order to achieve transaction interoperability across dissimilar IoT frameworks.

In some examples, the current state TXS of the transaction resource 322 may be set externally (e.g., PUT “state”=“INIT”) as a way to designate the IoT device 304 as an initiator of the transaction. An access control list (ACL) policy may be used to control who is authorized to post to the transaction resource 322. In other examples, the transaction resource 322 may have a default start state (e.g. “INIT”) to simplify initial deployment and recovery from system crashes.

In some examples, subsequent to completing a transaction, the protocol defined in the transaction resource 322 may produce properties that should persist beyond the lifetime of the transaction message resource(s) 324. The transaction engine 312 may update the application message resource(s) 326 to make certain transaction properties persistent after the lifetime of the transaction message resource(s) 324. Subsequently the IoT may clean up temporary transaction resources.

In some examples, multiple IoT devices with respective ones of the transaction resource 322 may implement a workflow process that has distributed sequencing control. A workflow process orchestration engine may describes a workflow process model, and then may partition the process model according to the respective workflow nodes (e.g., individual ones of the multiple IoT devices) such that the workflow step(s) between any two workflow node neighbors may form a transaction. A workflow node may maintain two instances of the transaction resource 322 such that the results of an A to B transaction may feed a B to C transaction.

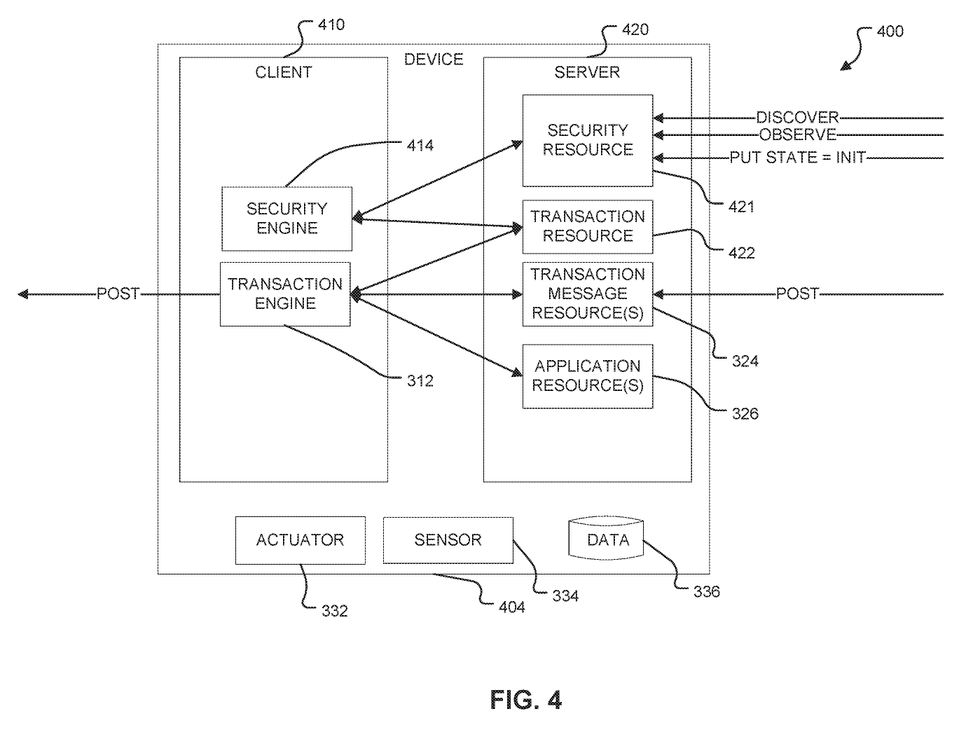

FIG. 4 is a block diagram of a transaction system 400 having an IoT device 404 according to some embodiments of the disclosure. The IoT device 404 may include both client components (e.g., to transmit messages/data) and server components (e.g., to receive messages/data) in a single device. Thus, the IoT device 404 may include a client 410 and a server 420. The client 410 may include a transaction engine 312 and a security engine 414. The server 420 may include a security resource 421, a transaction resource 422, a transaction message resource(s) 324, and an application message resource(s) 326. The IoT device 404 may include some of the same components as the IoT device 304 of FIG. 3. Those components that are common between the IoT device 404 and the IoT device 304 of FIG. 3 use common reference numbers. In the interests of brevity and clarity, description of the formation of these components will not be repeated.

The security resource 421 may include resource attributes such as resource type (RT) to indicate the type of secure transaction resource. The security resource 421 may also include resource properties, such as a reference to a key transaction (KX) resource responsible for establishing the transaction security association (KXR), a security association reference to an initiator device and responder device credentials (SXSA), message manifest that identifies properties included in a signature (SXM), an initiator device message nonce (SXIN), a responder device message nonce (RXRN), a per message signature (SXSIG), a signature algorithm block (SXALG), a cipher-text envelope (SXENV), an encryption algorithm block (SXEALG), and a reference to transaction resource (e.g., the transaction resource 422) enveloped by the security resource 421.

The transaction resource 422 may include resource properties, such as a current state of a transaction (e.g., TXS), a graph that defines reachable states/transitions (TXG), a collection resource with references to transaction message resources (TXC), a rolling hash of transactional messages exchanged (TXH), and a reference to secure transaction resource enveloping a transaction Resource instance (SXR). In some examples, the transaction resource 422 may further include a transaction identification (TXI) property and/or a hash algorithm property (TXHALG) that defines the hash algorithm used in TXH.

In operation, the security resource 421 and the security engine 414 may isolate the transaction resource 422 and the transaction engine 312 from external references/interactions. All resource actions on the transaction resource 422 may be intercepted by the security resource 421 and security considerations may be applied. All transaction engine 312 actions emanating from the client 410 maybe intercepted by the security engine 414, and secure enveloping may be applied. Therefore, the security engine 414 and the security resource 421 may provide an added layer of security to in performance of a secured transaction.

Internally, the transaction engine 312 may be informed by the transaction resource 422 on the server 420 on the same platform regarding a current state TXS and an authorized state graph TXG. The transaction engine 312 may use the state graph TXG of the transaction resource 322 to control when to POST messages that further the protocol and when to take remedial actions. The transaction engine 312 may be further informed by the transaction message resource(s) 324 regarding types of information that are acceptable to POST to a peer device (not shown). However, rather than posting directly to a peer device, an action to POST from the transaction engine 312 may be intercepted by the security engine 414, and security association protocols informed by the security resource 421 may be applied to the action from the transaction engine 312 prior to performing the POST. The security resource 421, the transaction resource 422, the transaction message resource(s) 324, and the application message resource(s) 326 may be hosted by the server 420 on the IoT device 404 so that POST responses originating from the peer device may likewise continue the transaction. The security resource 421 may intercept discovery requests, observe requests, and PUT requests, directed to the transaction resource 422 and may apply security protocols to the discovery requests, observe requests, and PUT requests prior to passing them onto the transaction resource 422. Internally, the transaction resource 422 may process the discovery requests, observe requests, and PUT requests normally after the security protocols have been applied.

In some examples, all or a portion of the security engine 414, the security resource 421, and the memory 336 may be protected using a secured resource manager (SRM) and a trusted execution environment (TEE). The SRM and TEE may prevent the secure transaction from being compromised.

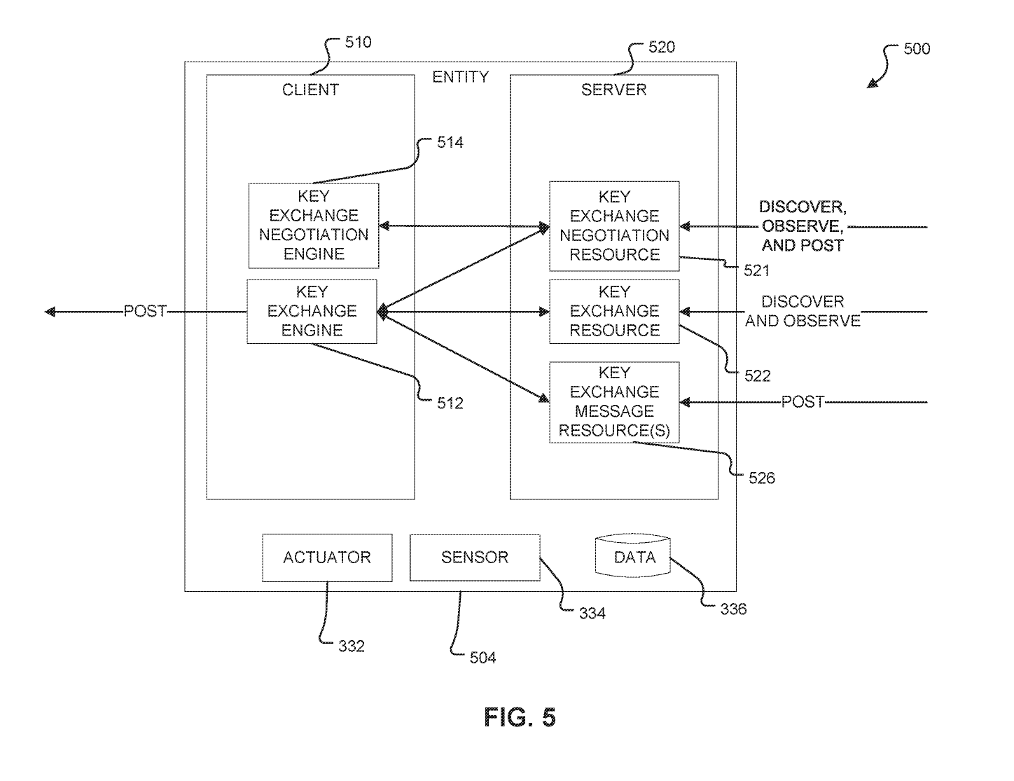

FIG. 5 is a block diagram of a key exchange transaction system 500 having an IoT device 504 according to some embodiments of the disclosure. The IoT device 504 may include both client components (e.g., to transmit messages/data) and server components (e.g., to receive messages/data) in a single device. Thus, the IoT device 504 may include a client 510 and a server 520. The client 510 may include a key exchange engine 512 and a key exchange negotiation engine 514. The server 520 may include a key exchange negotiation resource 521, a key exchange resource 522, and key exchange message resource(s) 524. In some examples, the IoT device 504 a memory 536 to store data.

The key exchange negotiation resource 521 may be used to perform a key exchange resource selection negotiation to select a key exchange resource used to exchange security keys between the IoT device 504 and a peer device. In an example, the key exchange negotiation resource 521 and the peer device may each compile respective lists of supported key exchange resources (e.g., including the key exchange resource 522) in a preferred order, exchange the lists, and compare the lists to select a most preferred key exchange resource that is common between the lists, and exchange confirmations of the selections. The key exchange negotiation resource 521 may include a resource attributes such as resource type (RT) to indicate the key exchange negotiation resource. The key exchange negotiation resource 521 may also include resource properties, such as a key exchange negotiation instance identifier (ID), The key exchange negotiation resource 521 may also properties, such as include a key exchange negotiation engine (e.g., device) initiating the key exchange negotiation protocol (I), key exchange negotiation engine (e.g., device) responding to the key exchange negotiation protocol (R), a reference to the key exchange resource the current key exchange negotiation instance supports (KXR), a prioritized (e.g., highest priority first) list of key exchange resource types that the IoT device 504 supports (KXL), a selected key exchange resource (SKX), and a transaction resource that selects the strongest common key exchange algorithm that is common to the IoT device 504 and the peer device (BTX).

In some examples, the key exchange resource types supported by the IoT device 504 may be based on a different framework than the key exchange resource types that the peer device supports. Therefore, a logical analysis may be performed to determine overlap for two different FSA expressions of the key exchange resource. For example, a mapping function (e.g., graphing analysis) may be implemented between a first IoT framework associated with the IoT device 504 and a second IoT framework associated with the peer device to establish whether the two key exchange resource FSA protocols are equivalent in order to achieve transaction interoperability across dissimilar IoT frameworks. The mapping function may be performed by the IoT device 504, the peer device, or a translation gateway (e.g., or similar bridging function) through which the IoT device 504, and the peer device are connected. In some examples, the graphs may also not need to overlap completely. For example, if the states of a first key exchange resource are completely overlap a subset of states of a second key exchange resource (i.e., the second key exchange resource includes additional steps/states), it may be recognized that device hosting the second key exchange resource is capable of ‘executing’ the first key exchange resource.

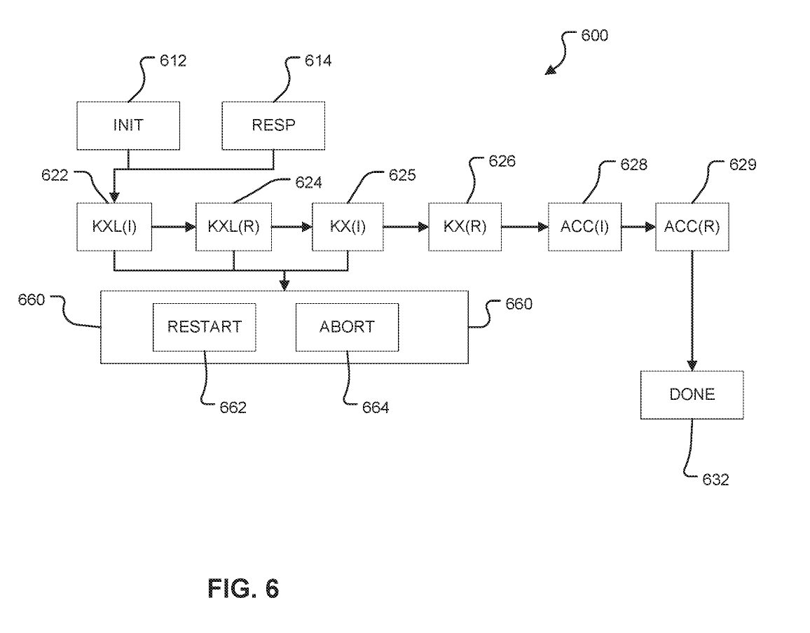

The BTX may include a resource attribute (RT) indicating the type, and may include a state graph that defines the method for selecting the strongest common key exchange algorithm. FIG. 6 depicts a block diagram of an exemplary BTX transaction graph TXG 600 in accordance with an embodiment of the disclosure. The TXG 600 may include a FSA. The TXG 600 may include start states of an init state 612 and a resp state 614. The protocol states for the TXG 600 may include a KXL(I) state 622, a KXL(R) state 624, a KX(I) state 625, a KX(R) state 626, a ACC(I) state 628, and a ACC(R) state 629. The error states 660 may include a restart state 662 and an abort state 664. The TXG 600 may further include a done state 632. The TXG 600 process may include the initiating device posting an initiator key exchange resource list at the KXL(I) state 622. The TXG 600 process may move to the KXL(R) state 624 when the responding device has posted a responder key exchange resource list. The initiating device may compare the lists and select a strongest common key exchange algorithm. Likewise, the responding device may compare the lists and select a strongest common key exchange algorithm. The TXG 600 process may move to the KX(I) state 625 when the initiating device has posted an initiator selected key exchange resource. The TXG 600 process may move to the KX(R) state 626 when the responding device has posted a responder selected key exchange. The initiating device may compare the selected key exchange resources to determine a match. Likewise, the responding device may compare the selected key exchange resources to determine a match. If a match exists, the TXG 600 process may move to the ACC(I) state 628 when the initiating device has posted an accept message. The TXG 600 process may move to the ACC(R) state 629 when the responding device has posted an accept message. Finally, the TXG 600 process may move to the done state 632 when the key exchange negotiation is complete. While the TXG 600 of FIG. 6 is specific to a key exchange negotiation transaction, it is understood that a similar approach could be implemented to negotiate other types of transactions.

Turning back to FIG. 5, the key exchange resource 522 may be used to perform exchange keys between the IoT device 504 and a peer device. The key exchange resource 522 may include a resource attributes such as resource type (RT) to indicate the key exchange resource type. The key exchange resource 522 may also include resource properties, such as a reference to the key exchange negotiation resource (KXNR) and other properties specific (e.g., graphs) to the key exchange algorithm supported by the key exchange resource 522. An example may be a sigma protocol for a key exchange. The sigma transaction key exchange may include a RT attribute indicating the sigma key exchange resource. The sigma transaction key exchange may further include a transaction graph.

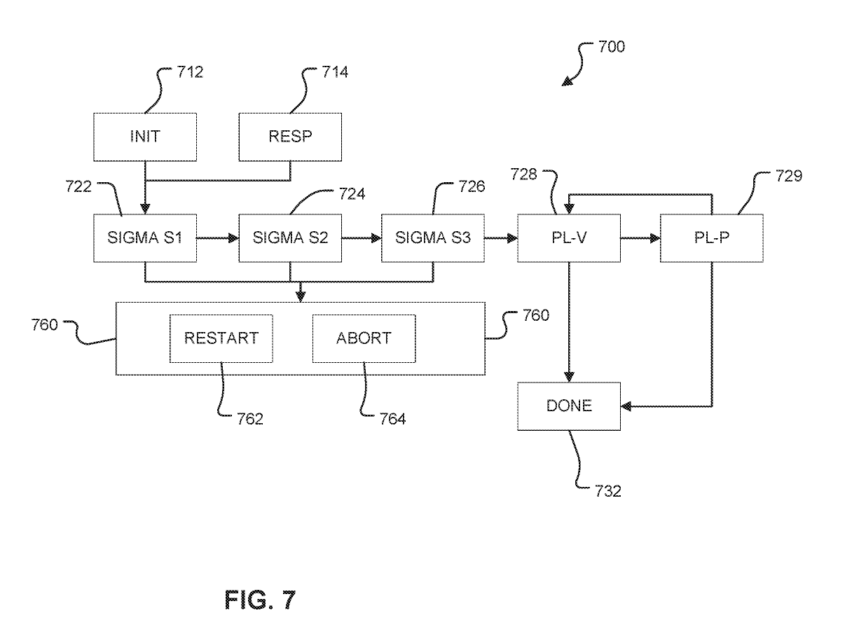

FIG. 7 depicts a block diagram of an exemplary sigma version 2 key exchange transaction graph (TXG) 700 in accordance with an embodiment of the disclosure. The TXG 700 may include a FSA. The TXG 700 may include start states of an init state 712 and a resp state 714. The protocol states for the TXG 700 may include a sigma S1 state 722, a sigma S2 state 724, a sigma S3 state 726, a PL-V state 728, and a PL-P state 729. The error states 760 may include a restart state 762 and an abort state 764. The TXG 700 may further include a done state 732. The TXG 700 process may include the initiating device posting a sigma S1 message at the sigma S1 state 722. The TXG 700 process may move to the sigma S2 state 724 when the responding device has posted a sigma S2 message. The TXG 700 process may move to the sigma S3 state 726 when the initiating device has posted a sigma S3 message. The TXG 700 process may move to the sigma S3 state 726 when the responding device has posted a responder selected key exchange. The TXG 700 process may move to the PL-V state 728 when the initiating device has posted a verifier payload encrypted with a session key. The TXG 700 process may move to the PL-P state 729 when the responding device has posted a prover payload encrypted with a session key. Finally, the TXG 700 process may move to the done state 732 when the key exchange is complete.

Turning back to FIG. 5, in operation, the key exchange negotiation engine 514 may interface with the key exchange negotiation resource 521 to perform the key exchange negotiation and selection, including posting messages to perform the negotiation process. The key exchange engine 512 may interface with the key exchange negotiation resource 521 to initiate the key exchange negotiation, and may interface with the key exchange resource 522 to perform the key exchange.

In some examples, all or a portion of the key exchange engine 512, the key exchange negotiation engine 514, the key exchange negotiation resource 521, the key exchange resource 522, and the memory 536 may be protected using a key exchange resource manager (KxRM) and a trusted execution environment (TEE). The SRM and TEE may prevent the key exchange transaction from being compromised.

The method 800 may be implemented in the system 100 of FIG. 1, the system 300 of FIG. 3, or the system 400 of FIG. 4.

The method 800 may include determining a current state based on a current state property of a transaction resource, at 810. The transaction resource may be defined as a finite state automaton. The transaction resource may include the transaction resource 110 or the transaction resource 150 of FIG. 1, or the transaction resource 322 of FIG. 3. The determination may be performed by a transaction engine, such as the transaction engine 103 or the 105 of FIG. 1, the transaction engine 312 of FIG. 3, and/or the transaction engine 312 of FIG. 4.

The method 800 may further include determining a next state based on a state graph property of the transaction resource, at 820. The method 800 may further include posting a message to the peer device based on the current state and the next state, at 830. In some examples, the method 800 may further include receiving and storing a post message from the peer device, and updating the current state property of the transaction resource in response to the post message. In some examples, the method 800 may further include, in response to a determination that the received post message is to persist after completion of the transaction, moving the received post message to an application resource (e.g., the application message resource(s) 326 of FIG. 3 or 4). The method 800 may further include, in response to receipt of the post message, posting a response message to indicate receipt of the post message. The method 800 may further include initiating the transaction as an initiating party. The method 800 may further include initiating the transaction as a responding party. The method 800 may further include receiving a put command to set the current state property to a start state.

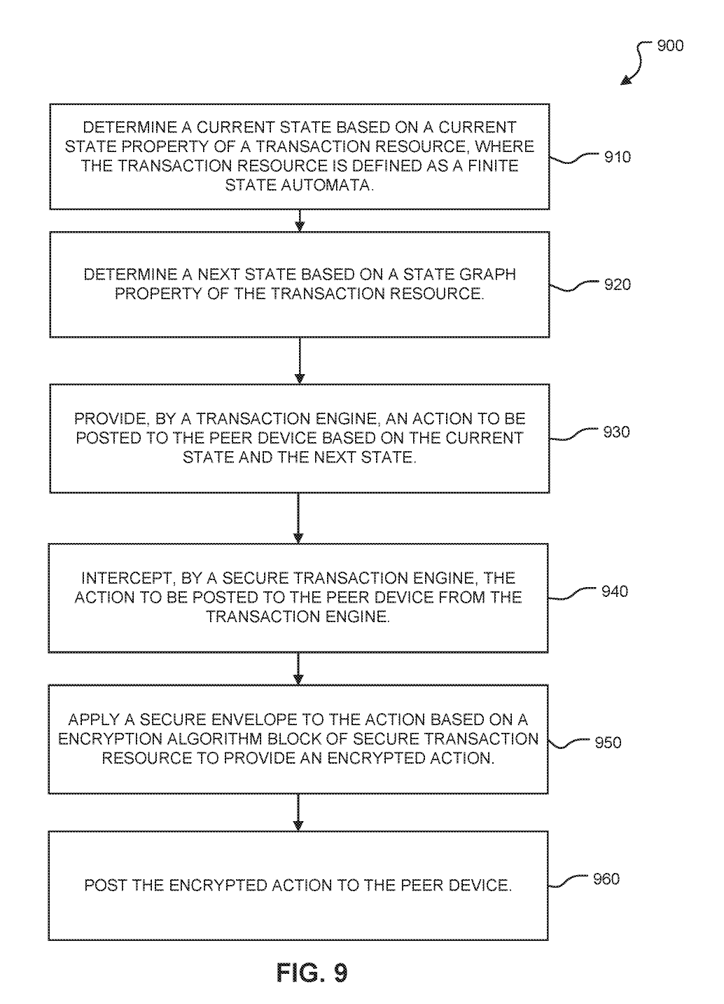

FIG. 9 illustrates a flow diagram of a method 900 to a transaction with a peer device in accordance with some embodiments of the disclosure. The method 900 may be implemented in the system 100 of FIG. 1, the system 300 of FIG. 3, or the system 400 of FIG. 4.

The method 900 may include determining a current state based on a current state property of a transaction resource, at 910. The transaction resource may be defined as a finite state automaton. The transaction resource may include the transaction resource 110 or the transaction resource 150 of FIG. 1, or the transaction resource 322 of FIG. 3. The determination may be performed by a transaction engine, such as the transaction engine 103 or the 105 of FIG. 1, the transaction engine 312 of FIG. 3, and/or the transaction engine 312 of FIG. 4.

The method 900 may further include determining a next state based on a state graph property of the transaction resource, at 920. The method 900 may further include providing, by a transaction engine, an action to be posted to the peer device based on the current state and the next state, at 930.

The method 900 may further include intercepting, by a secure transaction engine, the action to be posted to the peer device from the transaction engine, at 940. The secure transaction engine may include the security engine 414 of FIG. 4.

The method 900 may further include applying a secure envelope to the action based on an encryption algorithm block of secure transaction resource to provide an encrypted action, at 950. The secure transaction resource may include the security resource 421 of FIG. 4. The method 900 may further include posting the encrypted action to the peer device, at 960. The method 900 may further include intercepting a discovery request message, and applying security algorithms to the discovery request.

The secure transaction resource includes a reference to a key exchange transaction resource. The method 900 may further including performing a key exchange transaction with the peer device based on a key exchange algorithm identified in a key exchange transaction resource. The key exchange transaction resource may include the key exchange resource 522 of FIG. 5. The key exchange transaction may be performed by the key exchange engine 512 of FIG. 5.

The key exchange transaction resource further includes a key exchange negotiation resource property that references a key exchange negotiation transaction resource. The method 900 may further include performing the key exchange negotiation algorithm to select a key exchange algorithm to be used in the key exchange. The key exchange negotiation algorithm is based on a negotiation transaction resource reference in a property of the key exchange negotiation resource property. The key exchange negotiation transaction resource may include the key exchange negotiation resource 521 of FIG. 5. The key exchange negotiation transaction may be performed by the key exchange negotiation engine 514 of FIG. 5.

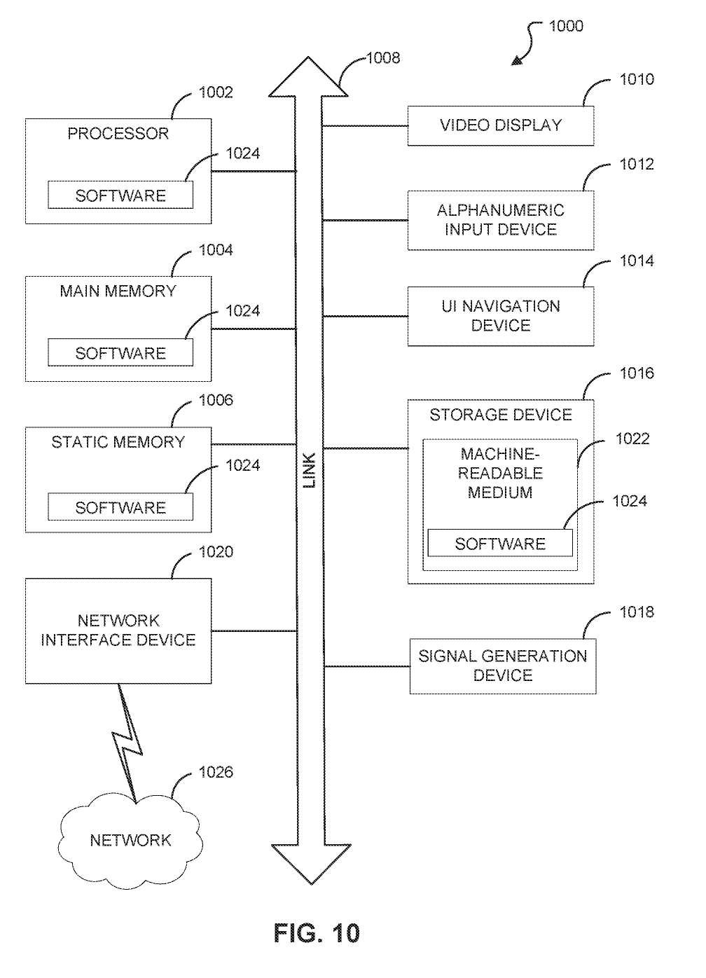

FIG. 10 is a block diagram illustrating a machine in the example form of a computer system 1000, within which a set or sequence of instructions may be executed to cause the machine to perform any one of the methodologies discussed herein, according to an example embodiment. In alternative embodiments, the machine operates as a standalone device or may be connected (e.g., networked) to other machines. In a networked deployment, the machine may operate in the capacity of either a server or a client machine in server-client network environments, or it may act as a peer machine in peer-to-peer (or distributed) network environments. The machine may be a personal computer (PC), a tablet PC, a hybrid tablet, a server, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Similarly, the term “processor-based system” shall be taken to include any set of one or more machines that are controlled by or operated by a processor (e.g., a computer) to individually or jointly execute instructions to perform any one or more of the methodologies discussed herein.

Example computer system 1000 includes at least one processor unit 1002 (e.g., a central processing unit (CPU), a graphics processing unit (GPU) or both, processor cores, compute nodes, etc.), a main memory 1004 and a static memory 1006, which communicate with each other via a link 1008 (e.g., bus). The computer system 1000 may further include a video display unit 1010, an alphanumeric input device 1012 (e.g., a keyboard), and a user interface (UI) navigation device 1014 (e.g., a mouse). In one embodiment, the video display unit 1010, input device 1012 and UI navigation device 1014 are incorporated into a touch screen display. The computer system 1000 may additionally include a storage device 1016 (e.g., a drive unit), a signal generation device 1018 (e.g., a speaker), a network interface device 1020, and one or more sensors (not shown), such as a global positioning system (GPS) sensor, compass, accelerometer, gyrometer, magnetometer, or other sensor.

The storage device 1016 includes a machine-readable medium device 1022 on which is stored one or more sets of data structures and instructions device 1024 (e.g., software) embodying or utilized by any one or more of the methodologies or functions described herein. The instructions device 1024 may also reside, completely or at least partially, within the main memory 1004, static memory 1006, and/or within the processor unit 1002 during execution thereof by the computer system 1000, with the main memory 1004, static memory 1006, and the processor unit 1002 also constituting machine-readable media.

While the machine-readable medium device 1022 is illustrated in an example embodiment to be a single medium, the term “machine-readable medium” may include a single medium or multiple media (e.g., a centralized or distributed database, and/or associated caches and servers) that store the one or more instructions device 1024. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions device 1024 may further be transmitted or received over a communications network device 1026 using a transmission medium via the network interface device 1020 utilizing any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., Bluetooth, Wi-Fi, 3G, and 4G LTE/LTE-A or WiMAX networks). The term “transmission medium” shall be taken to include any intangible medium that is capable of storing, encoding, or carrying instructions for execution by the machine, and includes digital or analog communications signals or other intangible medium to facilitate communication of such software.

Various illustrative components, blocks, configurations, modules, and steps have been described above generally in terms of their functionality. Skilled artisans may implement the described functionality in varying ways for each particular application, but such implementation decisions should not be interpreted as causing a departure from the scope of the present disclosure.

The previous description of the disclosed embodiments is provided to enable a person skilled in the art to make or use the disclosed embodiments. Various modifications to these embodiments will be readily apparent to those skilled in the art, and the principles defined herein may be applied to other embodiments without departing from the scope of the disclosure. Thus, the present disclosure is not intended to be limited to the embodiments shown herein but is to be accorded the widest scope possible consistent with the principles and novel features as previously described.

Examples, as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the software may reside on at least one machine-readable medium.

The term “module” is understood to encompass a tangible entity, be that an entity that is physically constructed, specifically configured (e.g., hardwired), or temporarily (e.g., transitorily) configured (e.g., programmed) to operate in a specified manner or to perform at least part of any operation described herein. Considering examples in which modules are temporarily configured, a module need not be instantiated at any one moment in time. For example, where the modules comprise a general-purpose hardware processor configured using software; the general-purpose hardware processor may be configured as respective different modules at different times. Software may accordingly configure a hardware processor, for example, to constitute a particular module at one instance of time and to constitute a different module at a different instance of time. The terms “application, process, or service,” or variants thereof, is used expansively herein to include routines, program modules, programs, components, and the like, and may be implemented on various system configurations, including single-processor or multiprocessor systems, microprocessor-based electronics, single-core or multi-core systems, combinations thereof, and the like. Thus, the terms “application, process, or service” may be used to refer to an embodiment of software or to hardware arranged to perform at least part of any operation described herein.

While a machine-readable medium may include a single medium, the term “machine-readable medium” may include a single medium or multiple media (e.g., a centralized or distributed database, and/or associated caches and servers).

### Additional Notes & Examples

Example 1 is a device to perform a transaction with a peer device, the device comprising: a server comprising: a transaction resource finite state automaton (FSA) to perform the transaction, wherein the transaction resource includes a current state property identifying a current state and a state graph property defining a protocol for the transaction; and a client comprising: a transaction engine to interface with the transaction resource to post messages to the peer device based on the current state property and the state graph property.

In Example 2, the subject matter of Example 1 optionally includes wherein the server further comprises a transaction message resource to receive and store a post message from the peer device, wherein the transaction engine is to update the current state property of the transaction resource in response to the post message.

In Example 3, the subject matter of Example 2 optionally includes wherein the server further comprises an application resource, wherein, in response to a determination that the received post message is to persist after completion of the transaction, the transaction engine is to move the received post message to the application resource.

In Example 4, the subject matter of Example 3 optionally includes wherein, in response to receipt of the post message, the transaction engine is to post a response message to indicate receipt of the post message.

In Example 5, the subject matter of any one or more of Examples 1-4 optionally include wherein the transaction engine is to initiate the transaction as the initiating party.

In Example 6, the subject matter of any one or more of Examples 1-5 optionally include wherein the transaction engine is to respond to an initiation post message from the peer device as the responding party.

In Example 7, the subject matter of any one or more of Examples 1-6 optionally include wherein the transaction resource includes a discoverable attribute to indicate whether the transaction resource is discoverable by the peer device.

In Example 8, the subject matter of any one or more of Examples 1-7 optionally include wherein the transaction resource to receive a put command to set the current state property to a start state.

In Example 9, the subject matter of any one or more of Examples 1-8 optionally include wherein the state graph property includes error states.

In Example 10, the subject matter of Example 9 optionally includes wherein the error states include an abort state to abort the transaction and a restart state to restart the transaction.

Example 11 is a device to perform a secure transaction with a peer device, the device comprising: a server comprising: a transaction resource finite state automaton (FSA) to perform a transaction, wherein the transaction resource includes a current state property identifying a current state and a state graph property defining a protocol for the transaction, and a secure transaction resource FSA to envelope the transaction resource to transition the transaction to the secure transaction, wherein the security protocol includes a key exchange resource reference property that references a key exchange resource responsible for establishing a security association with the peer device, and an encryption algorithm block property specifying an encryption algorithm; and a client comprising: a transaction engine to interface with the transaction resource to post messages to the peer device based on the current state property and the state graph property; and a secure transaction engine to interface with the transaction engine, the transaction resource, and the secure transaction resource to intercept actions from the transaction engine and to apply a secure envelope to the actions based on the encryption algorithm block of the secure transaction resource to provide encrypted actions, the secure transaction engine further to post the encrypted actions to the peer device.

In Example 12, the subject matter of Example 11 optionally includes wherein the server further comprises a transaction message resource to receive and store a post message from the peer device, wherein the transaction engine is to update the current state property of the transaction resource in response to the post message.

In Example 13, the subject matter of any one or more of Examples 11-12 optionally include wherein the server further comprises an application resource, wherein, in response to a determination that the received post message is to persist after completion of the transaction, the transaction engine is to move the received post message to the application resource.

In Example 14, the subject matter of any one or more of Examples 11-13 optionally include wherein the secure transaction resource is to intercept discovery request messages and to apply security algorithms to the discovery request.

In Example 15, the subject matter of any one or more of Examples 11-14 optionally include wherein: the server further comprising the key exchange transaction resource FSA to perform a key exchange transaction with the peer device, wherein the key exchange transaction resource includes a key exchange algorithm property that defines the key exchange algorithm to receive exchange a key, wherein the secure envelope applied by the secure transaction engine is based on the key; and the client further comprising a key exchange transaction engine to interface with the key exchange transaction resource to perform the key exchange algorithm.

In Example 16, the subject matter of Example 15 optionally includes wherein the key exchange transaction resource further includes a key exchange negotiation resource property that references a key exchange negotiation transaction resource, wherein: the server further includes a key exchange negotiation transaction resource FSA to define a key exchange negotiation algorithm to negotiate with the peer device to select the key exchange algorithm from a plurality of supported key exchange algorithms, wherein the key exchange negotiation transaction resource includes a state graph property defining a protocol for the key exchange negotiation algorithm; and the client further comprising a key exchange negotiation transaction engine to interface with the key exchange negotiation transaction resource to perform the key exchange negotiation algorithm.

In Example 17, the subject matter of Example 16 optionally includes the plurality of supported key exchange algorithms may be determined based on a graph analysis to determine compatibility between key exchange resources of peer devices and key exchange resources stored at the device.

In Example 18, the subject matter of any one or more of Examples 15-17 optionally include wherein the key exchange algorithm is a sigma key exchange algorithm.

Example 19 is a device to perform a negotiation transaction with a peer device, the device comprising: a server comprising: a negotiation transaction resource finite state automaton (FSA) to perform the negotiation transaction to select a transaction resource to perform a transaction, wherein the transaction resource includes wherein the negotiation transaction resource includes a state graph property defining a protocol for the negotiation algorithm; and a client comprising: a negotiation transaction engine to interface with the negotiation transaction resource to post messages to the peer device based on the state graph property.

In Example 20, the subject matter of Example 19 optionally includes wherein the state graph property includes an initiator list exchange state indicating that an initiator supported transaction list has been posted by the negotiation transaction engine and a responder list exchange state indicating that a responder supported transaction list has been posted by the peer device.

In Example 21, the subject matter of Example 20 optionally includes wherein the initiator supported transaction list includes external transaction resources that have been determined to be compatible with local transaction resources via a graph analysis, wherein the graph analysis includes a comparison of an external transaction resource of the external transaction resources with a local transaction resources of the local transaction resources to determine whether the states of the external transaction resource are a subset of states of the local transaction resource.

In Example 22, the subject matter of any one or more of Examples 20-21 optionally include wherein the negotiation transaction engine is to compare the initiator supported transaction list with the responder supported transaction list to select a transaction.

In Example 23, the subject matter of Example 22 optionally includes wherein the state graph property includes an initiator selected transaction state indicating that an initiator selected transaction has been posted by the negotiation transaction engine and a responder selected transaction state indicating that a responder selected transaction has been posted by the peer device.

In Example 24, the subject matter of Example 23 optionally includes wherein the negotiation transaction engine is to compare the initiator selected transaction with the responder selected transaction to determine a match.

Example 25 is a method to perform a transaction with a peer device, the method comprising: determining a current state based on a current state property of a transaction resource finite state automaton (FSA); determining a next state based on a state graph property of the transaction resource; and posting a message to the peer device based on the current state and the next state.

In Example 26, the subject matter of Example 25 optionally includes receiving and storing a post message from the peer device; and updating the current state property of the transaction resource in response to the post message.

In Example 27, the subject matter of Example 26 optionally includes in response to a determination that the received post message is to persist after completion of the transaction, moving the received post message to an application resource.

In Example 28, the subject matter of Example 27 optionally includes in response to receipt of the post message, posting a response message to indicate receipt of the post message.

In Example 29, the subject matter of any one or more of Examples 25-28 optionally include initiating the transaction as an initiating party.

In Example 30, the subject matter of any one or more of Examples 25-29 optionally include responding to an initiation post message from the peer device as a responding party.

In Example 31, the subject matter of any one or more of Examples 25-30 optionally include receiving a put command to set the current state property to a start state.

Example 32 is at least one machine readable medium including instructions that, when executed by a machine, cause the machine to perform any method of Examples 25-31.

Example 33 is a system comprising means to perform any method of Examples 25-31.

Example 34 is a method to perform a secure transaction with a peer device, the method comprising: determining a current state based on a current state property of a transaction resource finite state automaton (FSA); determining a next state based on a state graph property of the transaction resource; and providing, by a transaction engine, an action to be posted to the peer device based on the current state and the next state; intercepting, by a secure transaction engine, the action to be posted to the peer device from the transaction engine; applying a secure envelope to the action based on an encryption algorithm block of secure transaction resource to provide an encrypted action; and posting the encrypted action to the peer device.

In Example 35, the subject matter of Example 34 optionally includes intercepting a discovery request message; and applying security algorithms to the discovery request.

In Example 36, the subject matter of any one or more of Examples 34-35 optionally include wherein the secure transaction resource includes a reference to a key exchange transaction resource, the method further comprising performing a key exchange transaction with the peer device based on a key exchange algorithm identified in a key exchange transaction resource.

In Example 37, the subject matter of Example 36 optionally includes wherein the key exchange transaction resource further includes a key exchange negotiation resource property that references a key exchange negotiation transaction resource, the method further comprising performing the key exchange negotiation algorithm to select a key exchange algorithm to be used in the key exchange, wherein the key exchange negotiation algorithm is based on a negotiation transaction resource reference in a property of the key exchange negotiation resource property.

In Example 38, the subject matter of Example 37 optionally includes wherein the key exchange algorithm is a sigma key exchange algorithm.

Example 39 is at least one machine readable medium including instructions that, when executed by a machine, cause the machine to perform any method of Examples 34-38.

Example 40 is a system comprising means to perform any method of Examples 34-38.

Example 41 is at least one machine readable medium including instructions to perform a transaction with a peer device, the instructions, when executed by a machine, cause the machine to perform operations comprising: determining a current state based on a current state property of a transaction resource finite state automaton (FSA); determining a next state based on a state graph property of the transaction resource; and posting a message to the peer device based on the current state and the next state.

In Example 42, the subject matter of Example 41 optionally includes receiving and storing a post message from the peer device; and updating the current state property of the transaction resource in response to the post message.

In Example 43, the subject matter of Example 42 optionally includes wherein the operations comprise, in response to a determination that the received post message is to persist after completion of the transaction, moving the received post message to an application resource.

In Example 44, the subject matter of Example 43 optionally includes the operations comprise, in response to receipt of the post message, posting a response message to indicate receipt of the post message.

In Example 45, the subject matter of any one or more of Examples 41-44 optionally include the operations comprise further comprising initiating the transaction as an initiating party.

In Example 46, the subject matter of any one or more of Examples 41-45 optionally include the operations comprise responding to an initiation post message from the peer device as a responding party.

In Example 47, the subject matter of any one or more of Examples 41-46 optionally include the operations comprise receiving a put command to set the current state property to a start state.

Example 48 is at least one machine readable medium including instructions to perform a transaction with a peer device, the instructions, when executed by a machine, cause the machine to perform operations comprising: determining a current state based on a current state property of a transaction resource finite state automaton (FSA); determining a next state based on a state graph property of the transaction resource; and providing, by a transaction engine, an action to be posted to the peer device based on the current state and the next state; intercepting, by a secure transaction engine, the action to be posted to the peer device from the transaction engine; applying a secure envelope to the action based on an encryption algorithm block of secure transaction resource to provide an encrypted action; and posting the encrypted action to the peer device.

In Example 49, the subject matter of Example 48 optionally includes wherein the operations comprise: intercepting a discovery request message; and applying security algorithms to the discovery request.

In Example 50, the subject matter of any one or more of Examples 48-49 optionally include wherein the secure transaction resource includes a reference to a key exchange transaction resource, wherein the operations further comprise performing a key exchange transaction with the peer device based on a key exchange algorithm identified in a key exchange transaction resource.

In Example 51, the subject matter of Example 50 optionally includes wherein the key exchange transaction resource further includes a key exchange negotiation resource property that references a key exchange negotiation transaction resource, wherein the operations further comprise performing the key exchange negotiation algorithm to select a key exchange algorithm to be used in the key exchange, wherein the key exchange negotiation algorithm is based on a negotiation transaction resource reference in a property of the key exchange negotiation resource property.

In Example 52, the subject matter of Example 51 optionally includes wherein the key exchange algorithm is a sigma key exchange algorithm.

Example 53 is a system to perform a transaction with a peer device, the system comprising: means for determining a current state based on a current state property of a transaction resource finite state automaton (FSA); means for determining a next state based on a state graph property of the transaction resource; and means for posting a message to the peer device based on the current state and the next state.

In Example 54, the subject matter of Example 53 optionally includes means for receiving and storing a post message from the peer device; and means for updating the current state property of the transaction resource in response to the post message.

In Example 55, the subject matter of Example 54 optionally includes in response to a determination that the received post message is to persist after completion of the transaction, means for moving the received post message to an application resource.

In Example 56, the subject matter of Example 55 optionally includes in response to receipt of the post message, means for posting a response message to indicate receipt of the post message.

In Example 57, the subject matter of any one or more of Examples 53-56 optionally include means for initiating the transaction as an initiating party.

In Example 58, the subject matter of any one or more of Examples 53-57 optionally include means for responding to an initiation post message from the peer device as a responding party.

In Example 59, the subject matter of any one or more of Examples 53-58 optionally include means for receiving a put command to set the current state property to a start state.

Example 60 is a system to perform a secure transaction with a peer device, the system comprising: means for determining a current state based on a current state property of a transaction resource finite state automaton (FSA); means for determining a next state based on a state graph property of the transaction resource; and means for providing, by a transaction engine, an action to be posted to the peer device based on the current state and the next state; means for intercepting, by a secure transaction engine, the action to be posted to the peer device from the transaction engine; means for applying a secure envelope to the action based on an encryption algorithm block of secure transaction resource to provide an encrypted action; and means for posting the encrypted action to the peer device.

In Example 61, the subject matter of Example 60 optionally includes means for intercepting a discovery request message; and means for applying security algorithms to the discovery request.

In Example 62, the subject matter of any one or more of Examples 60-61 optionally include wherein the secure transaction resource includes a reference to a key exchange transaction resource, the system further comprising means for performing a key exchange transaction with the peer device based on a key exchange algorithm identified in a key exchange transaction resource.

In Example 63, the subject matter of Example 62 optionally includes wherein the key exchange transaction resource further includes a key exchange negotiation resource property that references a key exchange negotiation transaction resource, the system further comprising means for performing the key exchange negotiation algorithm to select a key exchange algorithm to be used in the key exchange, wherein the key exchange negotiation algorithm is based on a negotiation transaction resource reference in a property of the key exchange negotiation resource property.

In Example 64, the subject matter of Example 63 optionally includes wherein the key exchange algorithm is a sigma key exchange algorithm.

Example 65 is a system configured to perform operations of any one or more of Examples 1-64.

Example 66 is a method for performing operations of any one or more of Examples 1-64.

Example 67 is a machine readable medium including instructions that, when executed by a machine cause the machine to perform the operations of any one or more of Examples 1-64.

Example 68 is a system comprising means for performing the operations of any one or more of Examples 1-64.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplate are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features may be grouped together to streamline the disclosure. However, the claims may not set forth features disclosed herein because embodiments may include a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

What is claimed is:

1. A device to perform a transaction with a peer device, the device comprising:
a server comprising:
a transaction resource finite state automaton (FSA) to perform the transaction, wherein the transaction resource includes a current state property identifying a current state and a state graph property defining a protocol for the transaction; and
a client comprising:
a transaction engine to interface with the transaction resource to post messages to the peer device based on the current state property and the state graph property.

2. The device of claim 1, wherein the server further comprises a transaction message resource to receive and store a post message from the peer device, wherein the transaction engine is to update the current state property of the transaction resource in response to the post message.

3. The device of claim 2, wherein the server further comprises an application resource, wherein, in response to a determination that the received post message is to persist after completion of the transaction, the transaction engine is to move the received post message to the application resource.

4. The device of claim 3, wherein, in response to receipt of the post message, the transaction engine is to post a response message to indicate receipt of the post message.

5. The device of claim 1, wherein the transaction engine is to initiate the transaction as the initiating party.

6. The device of claim 1, wherein the transaction engine is to respond to an initiation post message from the peer device as the responding party.

7. The device of claim 1, wherein the transaction resource includes a discoverable attribute to indicate whether the transaction resource is discoverable by the peer device.

8. The device of claim 1, wherein the transaction resource to receive a put command to set the current state property to a start state.

9. The device of claim 1, wherein the state graph property includes error states.

10. A device to perform a negotiation transaction with a peer device, the device comprising:
a server comprising:
a negotiation transaction resource finite state automaton (FSA) to perform the negotiation transaction to select a transaction resource to perform a transaction, wherein the transaction resource includes wherein the negotiation transaction resource includes a state graph property defining a protocol for the negotiation algorithm; and
a client comprising:
a negotiation transaction engine to interface with the negotiation transaction resource to post messages to the peer device based on the state graph property.

11. The device of claim 10, wherein the state graph property includes an initiator list exchange state indicating that an initiator supported transaction list has been posted by the negotiation transaction engine and a responder list exchange state indicating that a responder supported transaction list has been posted by the peer device.

12. The device of claim 11, wherein the initiator supported transaction list includes external transaction resources that have been determined to be compatible with local transaction resources via a graph analysis, wherein the graph analysis includes a comparison of an external transaction resource of the external transaction resources with a local transaction resources of the local transaction resources to determine whether the states of the external transaction resource are a subset of states of the local transaction resource.

13. The device of claim 11, wherein the negotiation transaction engine is to compare the initiator supported transaction list with the responder supported transaction list to select a transaction.

14. The device of claim 13, wherein the state graph property includes an initiator selected transaction state indicating that an initiator selected transaction has been posted by the negotiation transaction engine and a responder selected transaction state indicating that a responder selected transaction has been posted by the peer device.

15. The device of claim 14, wherein the negotiation transaction engine is to compare the initiator selected transaction with the responder selected transaction to determine a match.

16. A method to perform a secure transaction with a peer device, the method comprising:
determining a current state based on a current state property of a transaction resource finite state automaton (FSA);
determining a next state based on a state graph property of the transaction resource; and
providing, by a transaction engine, an action to be posted to the peer device based on the current state and the next state;
intercepting, by a secure transaction engine, the action to be posted to the peer device from the transaction engine;
applying a secure envelope to the action based on an encryption algorithm block of secure transaction resource to provide an encrypted action; and
posting the encrypted action to the peer device.

17. The method of claim 16, further comprising:
intercepting a discovery request message; and
applying security algorithms to the discovery request.

18. The method of claim 16, wherein the secure transaction resource includes a reference to a key exchange transaction resource, the method further comprising performing a key exchange transaction with the peer device based on a key exchange algorithm identified in a key exchange transaction resource.

19. The method of claim 18, wherein the key exchange transaction resource further includes a key exchange negotiation resource property that references a key exchange negotiation transaction resource, the method further comprising performing the key exchange negotiation algorithm to select a key exchange algorithm to be used in the key exchange, wherein the key exchange negotiation algorithm is based on a negotiation transaction resource reference in a property of the key exchange negotiation resource property.

20. The method of claim 19, wherein the key exchange algorithm is a sigma key exchange algorithm.

21. At least one machine readable medium including instructions to perform a transaction with a peer device, the instructions, when executed by a machine, cause the machine to perform operations comprising:
determining a current state based on a current state property of a transaction resource finite state automaton (FSA);
determining a next state based on a state graph property of the transaction resource; and
providing, by a transaction engine, an action to be posted to the peer device based on the current state and the next state;
intercepting, by a secure transaction engine, the action to be posted to the peer device from the transaction engine;
applying a secure envelope to the action based on an encryption algorithm block of secure transaction resource to provide an encrypted action; and
posting the encrypted action to the peer device.

22. The at least one machine readable medium of claim 21, wherein the operations comprise:
intercepting a discovery request message; and
applying security algorithms to the discovery request.

23. The at least one machine readable medium of claim 21, wherein the secure transaction resource includes a reference to a key exchange transaction resource, wherein the operations further comprise performing a key exchange transaction with the peer device based on a key exchange algorithm identified in a key exchange transaction resource.

24. The at least one machine readable medium of claim 23, wherein the key exchange transaction resource further includes a key exchange negotiation resource property that references a key exchange negotiation transaction resource, wherein the operations further comprise performing the key exchange negotiation algorithm to select a key exchange algorithm to be used in the key exchange, wherein the key exchange negotiation algorithm is based on a negotiation transaction resource reference in a property of the key exchange negotiation resource property.

25. The at least one machine readable medium of claim 24, wherein the key exchange algorithm is a sigma key exchange algorithm.
